(19) United States
(12) Patent Application Publication
(10) Pub. No.: US 2019/0019152 A1
(43) Pub. Date: Jan. 17, 2019

(54) SYSTEMS AND METHODS FOR EMPLOYEE PROXIMITY TRACKING

(71) Applicant: Walmart Apollo, LLC, Bentonville, AR (US)

(72) Inventors: Andrew Millhouse, Gilbert, AZ (US); John S. Meredith, Bentonville, AR (US)

(21) Appl. No.: 16/032,015

(22) Filed: Jul. 10, 2018

Related U.S. Application Data
(60) Provisional application No. 62/531,045, filed on Jul. 11, 2017.

(51) Int. Cl. G06Q 10/10; G06F 12/0802; H04W 4/029

(52) U.S. Cl. CPC G06Q 10/105; G06F 2212/45; H04W 4/029; G06F 12/0802

(57) ABSTRACT

An employee proximity tracking system that includes a central computing system and an employee proximity tracking application executing on a mobile device. Data signals are received at a first power level by the mobile device executing the proximity tracking application The first power level is indicative of a first distance of the employees from the mobile device, triggering a caching of action items associated with the respective employees by the central computing system. Data signals received at a second power level are indicative of the employees further approaching the mobile device, generating a user interface enabling selection via the proximity tracking application of a particular user. The central computing system forwards responsive cached action items to the proximity tracking application in response to the selection.

### CROSS-REFERENCE TO RELATED PATENT APPLICATIONS

This application claims priority to U.S. Provisional Application No. 62/531,045 filed on Jul. 11, 2017, the content of which is hereby incorporated by reference in its entirety.

### BACKGROUND

Many organizations today employ time management systems, personnel management systems, accounting systems and the like to maintain and track resources within the organization. Of particular concern for organizations is the ability to monitor and track employees requiring training or counseling.

### BRIEF DESCRIPTION OF THE DRAWINGS

To assist those of skill in the art in making and using a storage location determination system and associated methods, reference is made to the accompanying figures. The accompanying figures, which are incorporated in and constitute a part of this specification, illustrate one or more embodiments of the invention and, together with the description, help to explain the invention. Illustrative embodiments are shown by way of example in the accompanying drawings and should not be considered as limiting. In the figures:

FIG. 1 illustrates an exemplary network environment suitable for an employee proximity tracking system, in accordance with an exemplary embodiment;

FIG. 2 illustrates power levels detected by an employee proximity tracking application in the employee proximity tracking system, in accordance with an exemplary embodiment;

FIG. 3 illustrates a user interface generated by an employee proximity tracking application that displays one or more identifiers associated with one or more employee identification numbers for selection by a user, in accordance with an exemplary embodiment;

FIG. 4 illustrates a user interface generated by the employee proximity tracking application that displays one or more employee action items associated with a selected identifier, in accordance with an exemplary embodiment;

FIG. 5A-5B are flowcharts illustrating an exemplary method and a data message flow of the employee proximity tracking system; and

FIG. 6 is a schematic view of a central computing system used in the employee proximity tracking system, in accordance with an exemplary embodiment.

### DETAILED DESCRIPTION OF EMBODIMENTS

An employee proximity tracking system that includes a central computing system and an employee proximity tracking application executing on a mobile device is discussed. Data signals received at a first power level by the mobile device executing the proximity tracking application and thus indicative of a first distance of the employees from the mobile device trigger a caching of action items associated with the respective employees by the central computing system. Data signals received at a second power level that are indicative of the employees further approaching the mobile device generates a user interface enabling selection via the proximity tracking application of a particular user. The central computing system forwards responsive cached action items to the proximity tracking application in response to the selection.

Described in detail herein are methods and systems for an employee proximity tracking system. The system includes one or more sensors. Each sensor is associated with an employee and broadcasts an employee identification number. The system further includes a central computing system and a caching module executable on the central computing system. The system also includes an employee proximity tracking application installed on a mobile computing device and communicatively coupled to the central computing system.

In one embodiment, the central computing system includes a secondary memory storing employee action item data and a cache memory. The secondary memory may be a database or other data storage location. A caching module executed by the central computing system retrieves one or more candidate employee action items associated with one or more employee identification numbers from the secondary memory upon receiving the one or more employee identification numbers transmitted from the employee proximity tracking application. The caching module caches the one or more candidate employee action items into the cache memory. The caching module subsequently retrieves and transmits one or more selected employee action items of the one or more candidate employee action items from the cache memory to the employee proximity tracking application upon receiving an action items request transmitted from the employee proximity tracking application. The central computing system may further be configured to delete, from the cache, data for the one or more candidate employee action items after a predefined amount of time.

In an embodiment, the employee proximity tracking application may be configured to identify data signals received at a first power level from one or more candidate sensors by the mobile computing device upon which the employee proximity tracking application is executing. The data signals may include one or more employee identification numbers. The employee proximity tracking application may further be configured to transmit the one or more employee identification numbers to the caching module executing on the central computing system based on the identification of the first power level. The employee proximity tracking application may be further configured to identify data signals received at a second power level from one or more sensors of the one or more candidate sensors. The data signals received at a second power level may include one or more employee identification numbers and may include a picture and name of the employee. The employee proximity tracking application may be configured to transmit to the caching module executing on the central computing system, in response to a selection by a user, an action items request associated with one or more employee identification numbers based on the identification of the second power level. The action item request requests one or more employee action items associated with the one or more employee identification numbers.

The employee proximity tracking application may be configured to receive the one or more employee action items from the central computing system that are transmitted from the cache memory in response to the action items request. The employee proximity tracking application may also be configured to display, on an interface of the mobile computing device, the one or more employee action items for associated employee identification numbers. The one or more employee action items may include information related to at least one of coaching, warning, training, anniversaries, or milestones for an employee.

The employee proximity tracking system described herein increases a speed and efficiency of accessing employee information presented as employee action items based on employee proximity to the employee proximity tracking application. Identifying one or more employees associated with data signals at a first power level prompts the employee proximity tracking system to retrieve employee action items from a slower secondary memory and store the information into a quicker cache memory. The caching keeps the employee action items in a place where they are easily accessible but does not transmit the information until necessary. When an employee gets closer to the employee proximity tracking application and is identified via a data signal at a second power level, the employee action items can be quickly retrieved from the cache and displayed in the employee proximity tracking application. This allows a user of the employee proximity tracking application, such as a manager, to quickly view the employee action items for selected employees and speak with the employee, if needed.

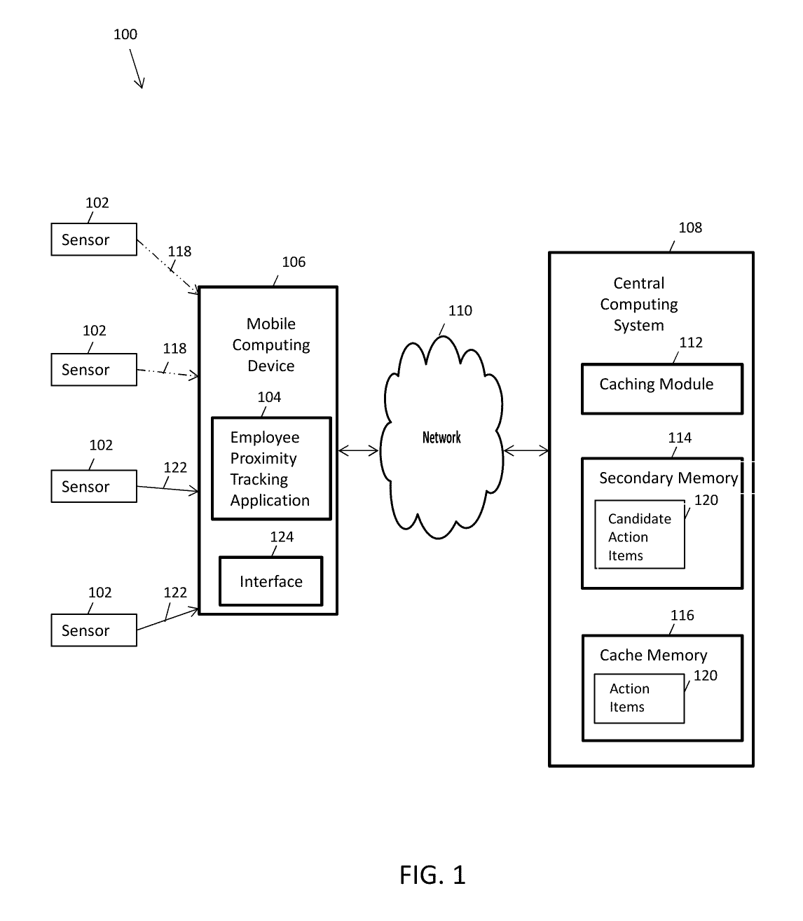

FIG. 1 illustrates an exemplary network environment 100 suitable for the employee proximity tracking system in an exemplary embodiment. The employee proximity tracking system includes one or more sensors 102 each broadcasting an employee identification number, each sensor 102 associated with an employee. The employee identification number may be accompanied by additional information such as, but not limited to, an employee name and picture. For example, in one embodiment, each employee may wear a badge that includes a beacon or other type of sensor configured to broadcast a signal containing data. For example, in one embodiment, the one or more sensors 102 are configured to transmit data signals using a radio frequency. The system further includes an employee proximity tracking application 104 installed on a mobile computing device 106 and communicatively coupled to a central computing system 108 via a wireless network 110. For example, the mobile computing device 106 may be a tablet or a smartphone operated by a facility manager. In an exemplary embodiment, the wireless network 110 is a Wi-Fi network. The employee proximity tracking application 104 is configured to receive data signals from the one or more sensors 102, as described herein. The one or more sensors 102 can wirelessly communicate 118, 122 with the employee proximity tracking application 104 using at least one of low level Wi-Fi, Bluetooth, or RFID capabilities.

The system further includes the central computing system 108, a caching module 112 executable on the central computing system 108, a secondary memory 114 storing employee action item data, and a cache memory 116. The employee proximity tracking application 104 may identify data signals 118 wirelessly received at a first power level from one or more candidate sensors 102. The data signal 118 includes one or more employee identification numbers and may include other data. The employee proximity tracking application 104 transmits via the wireless network 110 the one or more employee identification numbers to the central computing system 108 based on the identification of the first power level for the data signal 118.

The central computing system 108 retrieves and caches one or more candidate employee action items 120 associated with the one or more employee identification numbers from the secondary memory 114 into the cache memory 116 upon receiving the one or more employee identification numbers from the employee proximity tracking application 104. The cache memory 116 stores one or more candidate employee action items 120. For example, the secondary memory may be, but is not limited to, a database holding pending (candidate) employee action items indexed by employee identification number.

The employee proximity tracking application 104 may identify data signals 122 wirelessly received at a second power level from one or more sensors 102 of the one or more candidate sensors 102. The data signals 122 include one or more employee identification numbers and may include other information such as an employee name and picture. The employee proximity tracking application 104 displays on an interface 124 of the mobile computing device 106 one or more candidate identifiers that were detected in the signal having the second power level for selection by a user. For example, the user may be the manager of a facility. The employee proximity tracking application 104 receives a selection by the user of one or more identifiers of the one or more candidate identifiers (i.e. employee number, name, picture, etc.), and by extension, a selection of one or more employee identification numbers.

The employee proximity tracking application 104 transmits an action items request associated with the one or more employee identification numbers selected by the user. The action item request requests any action items associated with the one or more employee identification numbers. The central computing system 108 transmits the one or more employee action items 120 of the one or more candidate employee action items from the cache memory 116 to the employee proximity tracking application 104 upon receiving the action items request.

The employee proximity tracking application 104 receives the one or more employee action items 120 from the central computing system 108 transmitted from the cache memory 116 and displays on the interface 124 of the mobile computing device 106 the one or more employee action items 120 for an associated employee identification number. The one or more employee action items 120 may include information related to at least one of coaching, warning, training, anniversaries, or milestones for an employee. In some embodiments, the employee action items 120 include a color code identifying a level of urgency to draw the attention of the user of the mobile device.

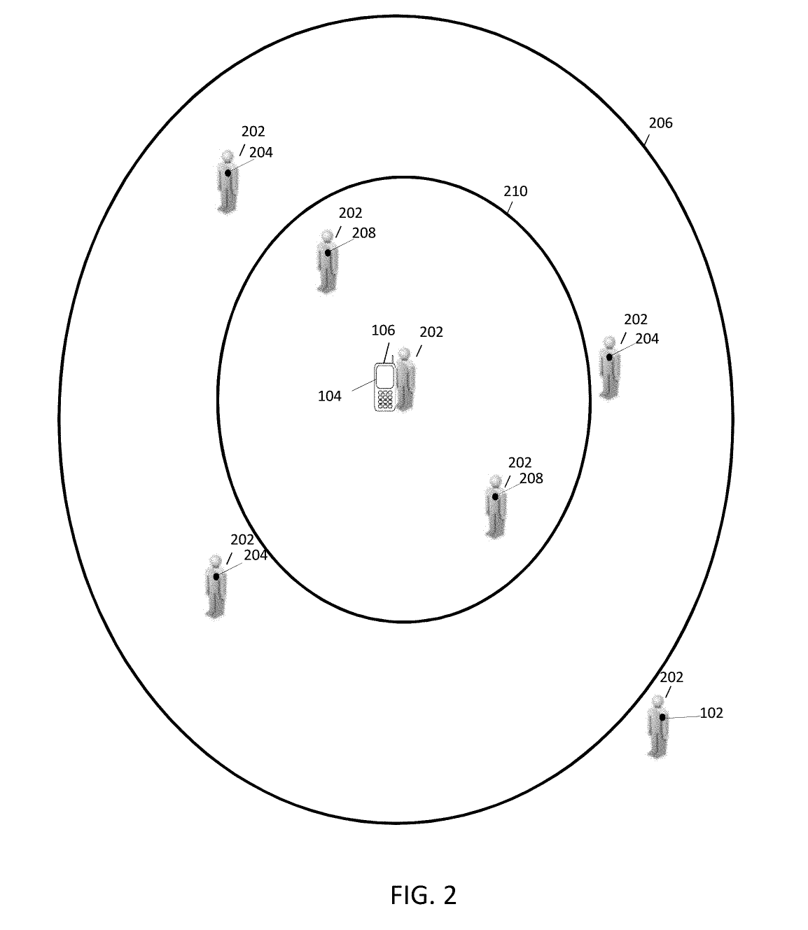

FIG. 2 illustrates the power levels received by the employee proximity tracking application 104 in the employee proximity tracking system. The system includes a plurality of sensors 102 each broadcasting an employee identification number, each sensor 102 associated with an employee 202. The system further includes an employee proximity tracking application 104 installed on a mobile computing device 106. The employee proximity tracking application 104 is configured to receive data signals from each sensor 102. Each sensor 102 can wirelessly communicate with the employee proximity tracking application 104 using at least one of low level Wi-Fi, Bluetooth, or RFID capabilities.

The employee proximity tracking application 104 identifies data signals 118 wirelessly received at a first power level from one or more candidate sensors 204, the data signal 118 including one or more employee identification numbers. The first power level identifies employees located within a first predefined distance 206 from the mobile computing device 106. As a non-limiting example, the proximity tracking location may detect employees at an exemplary 200 foot distance based on the first power level. The employee proximity tracking application 104 transmits the one or more employee identification numbers to the central computing system 108 based on the identification of the first power level to enable action items associated with those employees to be cached for quick retrieval at the central computing system in case the employees continue to approach the mobile device executing the proximity tracking application and the information is then requested by the user of the mobile device.

The employee proximity tracking application 104 further identifies data signals 122 wirelessly received at a second power level from one or more sensors 208 of the one or more candidate sensors 204. As a non-limiting example, the proximity tracking location may detect employees at an exemplary 50 foot distance. The second power level identify employees located within a second predefined distance 210 from the mobile computing device 106, wherein the first predefined distance 206 is a further distance from the mobile computing device 106 than the second predefined distance 210. The data signals 122 include one or more employee identification numbers and may be accompanied by associated information such as an employee name and employee picture. The employee proximity tracking application 104 displays on an interface of the mobile computing device 106, one or more identifiers associated with the one or more employee identification numbers identified at the second power level for selection by a user (i.e. the proximity tracking application displays information contained in the second data signal detected at the second power level). The employee proximity tracking application 104 transmits an action items request associated with one or more employee identification numbers based on the identification of the second power level, as described herein.

The detection of the first power level identifies employees located within the first predefined distance 206 from the mobile computing device 106 and the identification of the second power level identify employees located within the second predefined distance 210 from the mobile computing device 106, wherein the first predefined distance 206 is a further distance from the mobile computing device 106 than the second predefined distance 210. In one embodiment, a radio frequency meter or signal strength meter on mobile computing device 106 is used to measure a strength and/or power level of the data signals received from the sensors 102, 204, 208. It will be appreciated that the measured signal strength will increase in intensity as employees move closer to the mobile computing device that is executing the employee proximity tracking application.

The employee proximity tracking application 104 receives the one or more employee action items 120 from the central computing system 108 transmitted from the cache memory 116. The employee proximity tracking application 104 displays on the interface of the mobile computing device 106 the one or more requested employee action items for selected employees within close proximity. For example the proximity tracking system may enable a manager to select one employee among a group of employees to determine if any pending action items should be addressed with the selected employee.

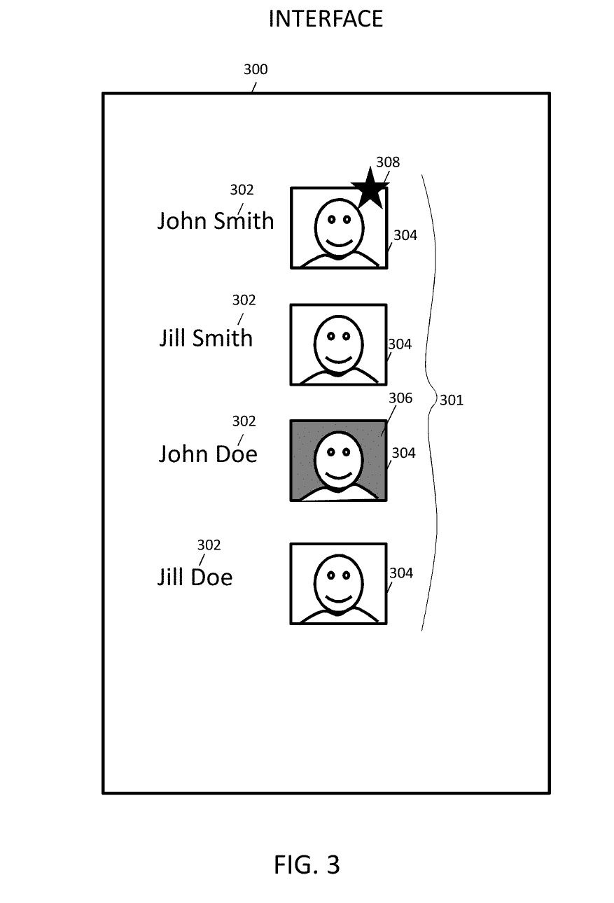

FIG. 3 illustrates, in an exemplary embodiment, an interface 300 generated by the employee proximity tracking application 104 that displays on the mobile computing device 106, one or more identifiers 301 associated with the one or more employee identification numbers for selection by a user. Each identifier includes at least one of a name 302 of an employee and a picture of the employee 304. The picture of the employee 304 may include a unique background 306. In some embodiments, an identifier may include a visual indicator 308, such as a star next to the name 302 of the employee and/or the picture of the employee 304, identifying a level of urgency.

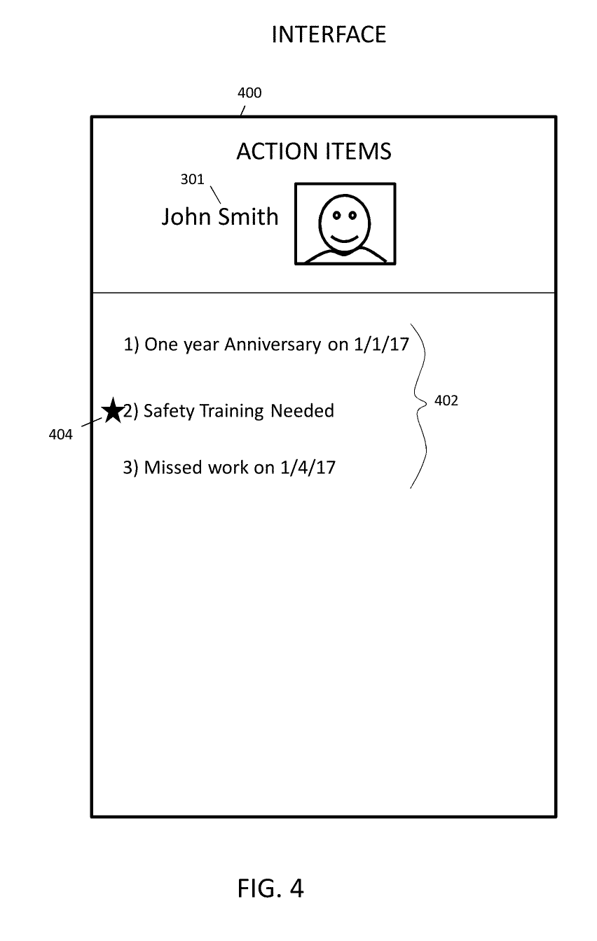

FIG. 4 illustrates, in an exemplary embodiment, an interface 400 generated by the employee proximity tracking application 104 that displays on the mobile computing device 106, one or more employee action items 402 for a selected identifier 301 shown in FIG. 3. The one or more employee action items 402 may include information related to at least one of coaching, warning, training, anniversaries, or milestones for the at least one employee. In some embodiments, an employee action item 402 may include a color code and/or visual indicator 404 identifying a level of urgency.

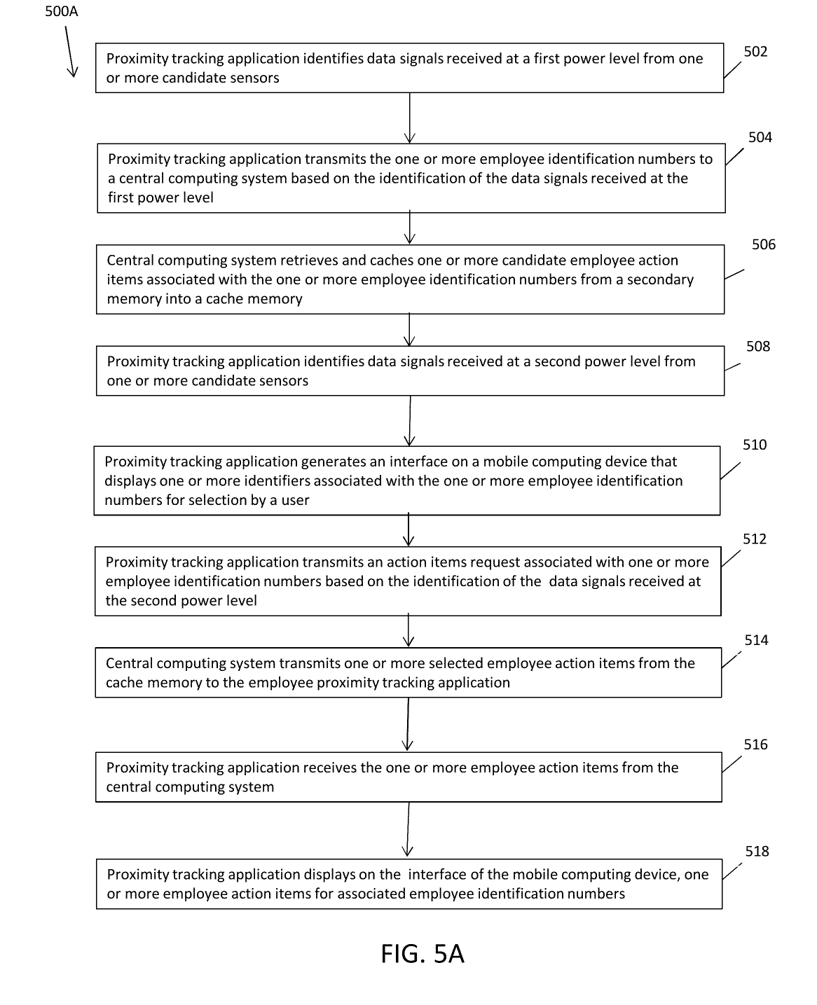

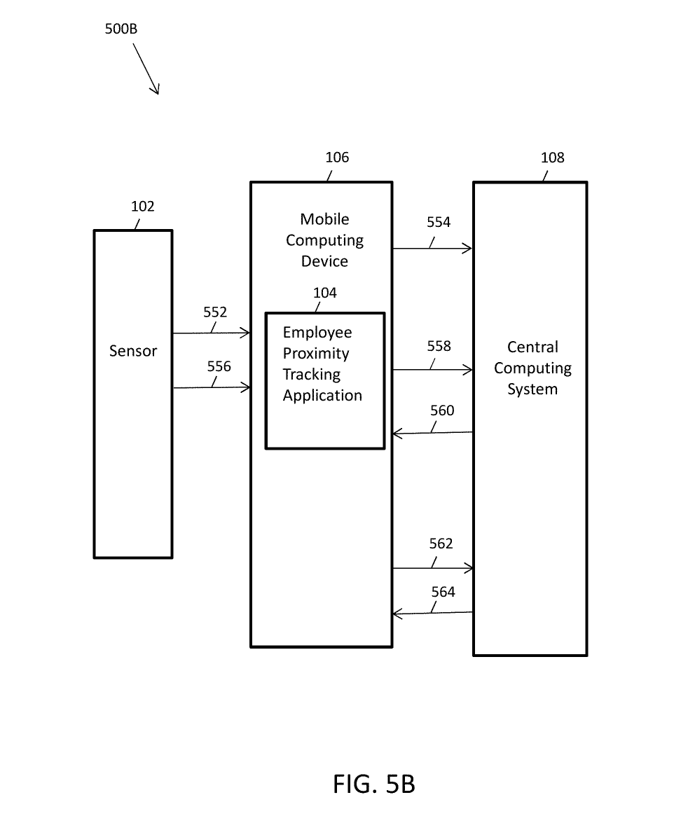

FIG. 5A is a flowchart illustrating an exemplary method 500A for employee proximity tracking using the employee proximity tracking system. At step 502, an employee proximity tracking application 104 that is installed on a mobile computing device 106 and communicatively coupled to a central computing system 108 identifies data signals transmitted at a first power level from one or more candidate sensors 102. The data signal includes one or more employee identification numbers. At step 504, the employee proximity tracking application 104 transmits the one or more employee identification numbers to the central computing system 108 based on the identification of the data signal at the first power level. At step 506, the central computing system 108 (and more specifically the caching module 112) retrieves and caches one or more candidate employee action items associated with the one or more employee identification numbers from a secondary memory into a cache memory upon receiving the one or more employee identification numbers from the employee proximity tracking application 104. Once present in the cache, the action items can be quickly retrieved if the employee continues to approach the employee manager or other user operating the employee proximity tracking application as explained herein and the user selects the employee via the employee proximity tracking application.

At step 508, the employee proximity tracking application 104 identifies data signals received at a second power level from one or more sensors 102 of the one or more candidate sensors 102. The data signals include one or more employee identification numbers. At step 510, the employee proximity tracking application 104 displays on an interface of the mobile computing device 106 one or more identifiers associated with the one or more employee identification numbers identified at the second power level for selection by a user. The identifiers may include, but are not limited to, employee names and/or pictures.

At step 512, the employee proximity tracking application 104 transmits an action items request associated with one or more employee identification numbers based on the identification of the data signals received at the second power level to the central computing system 108. The action item request requests any pending action items associated with the one or more employee identification numbers.

At step 514, the central computing system 108 transmits one or more selected employee action items of the one or more candidate employee action items from the cache memory to the employee proximity tracking application 104 upon receiving an action items request transmitted from the employee proximity tracking application 104.

At step 616, the employee proximity tracking application 104 receives the one or more employee action items from the central computing system 108 transmitted from the cache memory. At step 518, the employee proximity tracking application 104 displays on an interface of the mobile computing device 106 one or more employee action items responsive to the request.

FIG. 5B is a flowchart 500B illustrating dataflow between the sensors 102, the employee proximity tracking application 104, and the central computing system 108. The one or more candidate sensors 102 transmit 552 data signals received at a first power level by the employee proximity tracking application 104. The data signal includes one or more employee identification numbers. The employee proximity tracking application then transmits 554 the one or more employee identification numbers to the central computing system 108.

One or more sensors 102 of the one or more candidate sensors 102 transmit 556 data signals received at a second power level to the employee proximity tracking application 104. The data signals including one or more employee identification numbers.

In some embodiments, the employee proximity tracking application 104 transmits 558 the one or more employee identification numbers identified at the second power level to the central computing system 108 to request identifiers associated with the one or more employee identification numbers. For example, the central computing system may receive the employee identification number from the employee tracking application and return associated employee identifiers 560 such as pictures and names associated with the numbers. Alternatively, the sensors 102 may broadcast the employee identifiers along with the employee identification numbers as part of the data signals. Once the employee proximity tracking application 104 is in possession of the employee identifiers, it generates an interface on the mobile computing device that displays the one or more identifiers associated with the one or more employee identification numbers for selection by a user

The employee proximity tracking application transmits 562 to the central computing system 108 an action items request associated with one or more employee identification numbers in the signal identified at the second power level and selected by the user. The central computing system 108 transmits 564 one or more selected employee action items of the one or more candidate employee action items from the cache memory to the employee proximity tracking application 104.

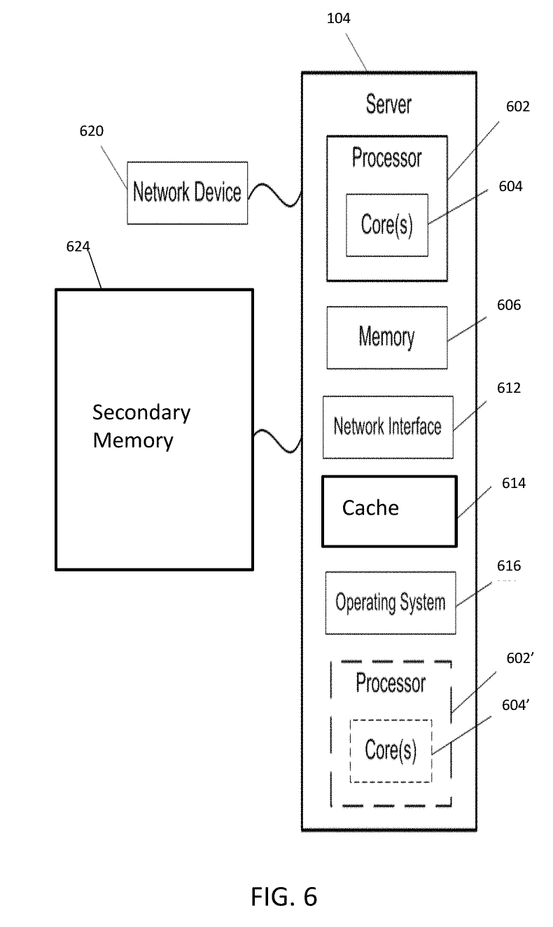

FIG. 6 is a schematic view of a central computing system 108. The central computing system 108 includes one or more non-transitory computer-readable media for storing one or more computer-executable instructions or software for implementing exemplary embodiments. The non-transitory computer-readable media can include, but are not limited to, one or more varieties of hardware memory, non-transitory tangible media (for example, one or more magnetic storage disks, one or more optical disks, one or more USB flashdrives), and the like. For example, a memory 606 included in the central computing system 108 can store computer-readable and computer-executable instructions or software for implementing exemplary embodiments. The central computing system 108 also includes a processor 602 and an associated core 604, and optionally, one or more additional processor(s) 602′ and associated core(s) 604′ (for example, in the case of computer systems having multiple processors/cores), for executing computer-readable and computer-executable instructions or software stored in memory 606 and other programs for controlling system hardware. Processor 602 and processor(s) 602′ can each be a single core processor or multiple core (604 and 604′) processor.

Memory 606 includes a computer system memory or random access memory, such as DRAM, SRAM, EDO RAM, and the like. Memory 606 can include other varieties of memory as well, or combinations thereof. The central computing system 108 includes secondary memory 624, such as a hard disk, hard-drive, CD-ROM, or other computer readable media, for storing employee action items. The secondary memory 624 may include one or more storage devices. In some embodiment, the secondary memory 624 may be used for storing any suitable information required to implement exemplary embodiments. A cache memory 614 stores one or more candidate employee action items associated with the one or more employee identification numbers retrieved from the secondary memory 624, as described herein. In an exemplary embodiment, the candidate employee action items are copied from the storage device 624 into the memory 606 and then into the cache memory 614.

The central computing system 108 can include a network interface 612 configured to interface via one or more network devices 622 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. The network interface 612 can include a built-in network adapter, network interface card, PCMCIA network card, card bus network adapter, wireless network adapter, USB network adapter, modem or any other device suitable for interfacing the central computing system 108 to any variety of network capable of communication and performing the operations described herein. Moreover, the central computing system 108 can be any computer system, such as a workstation, desktop computer, server, laptop, handheld computer, tablet computer, mobile computing or communication device, or other form of computing or telecommunications device that is capable of communication and that has sufficient processor power and memory capacity to perform the operations described herein.

The central computing system 108 can run any operating system 616, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 616 can be run in native mode or emulated mode. In an exemplary embodiment, the operating system 616 can be run on one or more cloud machine instances.

In some embodiments, the central computing system 108 may include a browser application. The browser application can, for example, enable a user to view employee action items. For example, in some embodiments, a user can interact with the central computing system 108 through a visual display device, such as a touch screen display or computer monitor, which can display one or more user interfaces that can be provided in accordance with exemplary embodiments. Visual display device may also display other aspects, elements and/or information or data associated with exemplary embodiments. The central computing system 108 may include other I/O devices for receiving input from a user, for example, a keyboard or any suitable multi-point touch interface, a pointing device (e.g., a pen, stylus, mouse, or trackpad). The keyboard and pointing device may be coupled to visual display device. The central computing system 108 may include other suitable conventional I/O peripherals.

The description herein is presented to enable any person skilled in the art to create and use a computer system configuration and related method and systems for improving access to electronic data. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step. Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

We claim:

1. An employee proximity tracking system, the system comprising:
one or more sensors each broadcasting an employee identification number, each sensor associated with an employee;
a caching module executable on a central computing system that includes a secondary memory storing employee action item data and a cache memory, the caching module when executed:
retrieves one or more candidate employee action items associated with one or more employee identification numbers from the secondary memory upon receiving the one or more employee identification numbers from an employee proximity tracking application,
caches the one or more candidate employee action items into the cache memory, the cache memory holding one or more candidate employee action items for a plurality of employees, and
transmits one or more selected employee action items of the one or more candidate employee action items from the cache memory to the employee proximity tracking application upon receiving an action items request transmitted from the employee proximity tracking application;
the employee proximity tracking application installed on a mobile computing device and communicatively coupled to the central computing system, the employee proximity tracking application configured to:
identify data signals received at a first power level from one or more candidate sensors, the data signals including one or more employee identification numbers;
transmit the one or more employee identification numbers to the central computing system based on the identification of the first power level;
identify data signals received at a second power level from one or more sensors of the one or more candidate sensors, the data signals including one or more employee identification numbers;
display on an interface of the mobile computing device, one or more identifiers associated with the one or more employee identification numbers identified at the second power level for selection by a user;
transmit an action items request associated with one or more employee identification numbers selected by the user based on the identification of the second power level to the central computing system, the action item request requesting one or more employee action items associated with the one or more employee identification numbers;
receive the one or more employee action items from the central computing system transmitted from the cache memory;
display, on an interface of the mobile computing device, one or more employee action items for associated employee identification numbers.

2. The system of claim 1, the central computing system further configured to:
delete, from the cache, data for the one or more candidate employee action items after a predefined amount of time.

3. The system of claim 1, wherein the first power level identifies employees located within a first predefined distance from the mobile computing device and the second power level identifies employees located within a second predefined distance from the mobile computing device, wherein the first predefined distance is a further distance from the mobile computing device than the second predefined distance.

4. The system of claim 1, wherein action items request is based on a selection of identifiers made by a user, each identifier includes at least one of a name of an employee and a picture of the employee.

5. The system of claim 1 wherein the employee action items include a color code identifying a level of urgency.

6. The system of claim 1, wherein the one or more sensors are configured to transmit data signals using a radio frequency.

7. The system of claim 1, wherein the one or more employee action items include information related to at least one of coaching, warning, training, anniversaries, or milestones for an employee.

8. A method for employee proximity tracking comprising:
identifying, by an employee proximity tracking application executing on a mobile computing device and communicatively coupled to a central computing system, data signals received at a first power level from one or more candidate sensors, the data signal including one or more employee identification numbers;
transmitting, by the employee proximity tracking application, the one or more employee identification numbers to the central computing system based on the identification of the first power level;
retrieving and caching, by the central computing system, one or more candidate employee action items associated with the one or more employee identification numbers from a secondary memory into a cache memory upon receiving the one or more employee identification numbers from the employee proximity tracking application, the cache memory holding one or more candidate employee action items for a plurality of employees.
identifying, by the employee proximity tracking application, data signals received at a second power level from one or more sensors of the one or more candidate sensors, the data signals including one or more employee identification numbers;
displaying, by the employee proximity tracking application, on an interface of the mobile computing device, one or more identifiers associated with the one or more employee identification numbers identified at the second power level for selection by a user;
transmitting, by the employee proximity tracking application to the central computing system, an action items request associated with one or more employee identification numbers selected by the user based on the identification of the second power level, the action item request requesting one or more employee action items associated with the one or more employee identification numbers;
transmitting, by the central computing system, one or more selected employee action items of the one or more candidate employee action items from the cache memory to the employee proximity tracking application upon receiving an action items request transmitted from the employee proximity tracking application;
receiving, by the employee proximity tracking application, the one or more employee action items from the central computing system transmitted from the cache memory; and
displaying, by the employee proximity tracking application, on the interface of the mobile computing device, one or more employee action items for associated employee identification numbers.

9. The method of claim 8, further comprising deleting, by the central computing system, from the cache, the data for the one or more candidate employee action items after a predefined amount of time.

10. The method of claim 8, wherein the first power level identifies employees located within a first predefined distance from the mobile computing device and the second power level identifies employees located within a second predefined distance from the mobile computing device, wherein the first predefined distance is a further distance from the mobile computing device than the second predefined distance.

11. The method of claim 8, wherein each identifier includes at least one of a name of an employee and a picture of the employee.

12. The method of claim 8, wherein the one or more sensors are configured to transmit data signals using a radio frequency.

13. The method of claim 8, wherein the one or more employee action items include information related to at least one of coaching, warning, training, anniversaries, or milestones for the at least one employee.

14. The method of claim 8, wherein the employee action items include a color code identifying a level of urgency.

15. A non-transitory computer-readable medium storing instructions for reducing network traffic and improved data transmission during employee proximity tracking, the instructions when executed causing at least one computing device to:
identify, by an employee proximity tracking application executable on a mobile computing device and communicatively coupled to a central computing system, data signals received at a first power level from one or more candidate sensors, the data signal including one or more employee identification numbers;
transmit, by the employee proximity tracking application, the one or more employee identification numbers to the central computing system based on the identification of the first power level;
retrieve and cache, by the central computing system, one or more candidate employee action items associated with the one or more employee identification numbers from a secondary memory into a cache memory upon receiving the one or more employee identification numbers from the employee proximity tracking application, the cache memory holding one or more candidate employee action items for a plurality of employees.
identify, by the employee proximity tracking application, data signals received at a second power level from one or more sensors of the one or more candidate sensors, the data signals including one or more employee identification numbers;
display, by the employee proximity tracking application, on an interface of the mobile computing device, one or more identifiers associated with the one or more employee identification numbers for selection by a user;
transmit, by the employee proximity tracking application, an action items request associated with one or more employee identification numbers based on the identification of the second power level, the action item request requesting one or more employee action items associated with the one or more employee identification numbers;
transmit, by the central computing system, one or more selected employee action items of the one or more candidate employee action items from the cache memory to the employee proximity tracking application upon receiving an action items request transmitted from the employee proximity tracking application;
receive, by the employee proximity tracking application, the one or more employee action items from the central computing system transmitted from the cache memory; and
display, by the employee proximity tracking application, on the interface of the mobile computing device, one or more employee action items for associated employee identification numbers.

16. The non-transitory computer readable medium of 15, further comprising deleting, by the proximity monitoring module, from the cache, the data for the one or more candidate employee action items after a predefined amount of time.

17. The non-transitory computer readable medium of 15, wherein each identifier includes at least one of a name of an employee and a picture of the employee.

18. The non-transitory computer readable medium of 15, wherein the employee action items include a color code identifying a level of urgency.

19. The non-transitory computer readable medium of 15, wherein the one or more sensors are configured to transmit data signals using a radio frequency.

20. The non-transitory computer readable medium of 15, wherein the first power level identifies employees located within a first predefined distance from the mobile computing device and the second power level identifies employees located within a second predefined distance from the mobile computing device, wherein the first predefined distance is a further distance from the mobile computing device than the second predefined distance.

21. The non-transitory computer readable medium of 15, wherein the one or more employee action items include information related to at least one of coaching, warning, training, anniversaries, or milestones for the at least one employee.
